(19) United States
(12) Patent Application Publication
(10) Pub. No.: US 2026/0111242 A1
(43) Pub. Date: Apr. 23, 2026

(54) METHODS AND APPARATUS TO IDENTIFY REVISIONS OF COMPONENTS

(71) Applicant: Ford Global Technologies, LLC, Dearborn, MI (US)

(72) Inventors: Daniel Lee Grohnke, Ann Arbor, MI (US); Jorge Rivas, Northville, MI (US)

(21) Appl. No.: 18/924,715

(22) Filed: Oct. 23, 2024

(51) Int. Cl. G06F 9/445

(52) U.S. Cl. CPC G06F 9/44505

(57) ABSTRACT

Disclosed examples include sending a first signal to a revision-identifying circuit of an electronically controllable component of a vehicle; receiving a second signal corresponding to a revision identifier of the electronically controllable component; accessing a tuning file having a file version corresponding to the revision identifier; and controlling the electronically controllable component based on the tuning file.

### FIELD OF THE DISCLOSURE

This disclosure relates generally to automobiles and, more particularly, to methods and apparatus to identify revisions of components.

### BACKGROUND

Automobiles have many subsystems and components that contribute to different functionalities. A suspension system has multiple components to manage suspension forces at automobile wheels. A drivetrain has multiple components to propel the automobile wheels based on power from a motor. A steering system includes multiple components to control wheel direction. The components have different mechanical and/or electrical properties to perform their various functions.

### SUMMARY

An example apparatus comprises interface circuitry to send a first signal to a revision-identifying circuit of an electronically controllable component of a vehicle, and receive a second signal corresponding to a revision identifier of the electronically controllable component, machine-readable instructions, and at least one processor circuit to be programmed by the machine-readable instructions to access a tuning file having a file version corresponding to the revision identifier, and control the electronically controllable component based on the tuning file.

At least one example non-transitory machine-readable medium comprises machine-readable instructions to cause at least one processor circuit to at least cause sending of a first signal to a revision-identifying circuit of an electronically controllable component of a vehicle, determine a revision identifier of the electronically controllable component based on a second signal from the revision-identifying circuit, access a tuning file having a file version corresponding to the revision identifier, and control the electronically controllable component based on the tuning file.

A method comprises sending a first signal to a revision-identifying circuit of an electronically controllable component of a vehicle, receiving a second signal corresponding to a revision identifier of the electronically controllable component, accessing a tuning file having a file version corresponding to the revision identifier, and controlling the electronically controllable component based on the tuning file.

### BRIEF DESCRIPTION OF THE DRAWINGS

FIG. 1 is a perspective view of a vehicle in which examples disclosed herein can be implemented.

FIG. 2 is a block diagram of an example implementation of the ECU of FIG. 1.

FIG. 3 is a block diagram of an example implementation of the system controller of FIG. 1.

FIG. 4 is a schematic diagram of example implementations of the electronically controllable component and the revision-identifying circuit of FIG. 1.

FIGS. 5A and 5B are example frequency response graphs of the example low-pass filter implementation of the revision-identifying circuit of FIG. 4.

FIG. 6 is a flowchart representative of example machine-readable instructions and/or example operations that may be executed, instantiated, and/or performed by example programmable circuitry to implement the ECU of FIGS. 1 and 2.

FIG. 7 is a flowchart representative of example machine-readable instructions and/or example operations that may be executed, instantiated, and/or performed by example programmable circuitry to implement the ECU and the vehicle service system of FIGS. 1-3.

FIG. 8 is a block diagram of an example processing platform including programmable circuitry structured to execute, instantiate, and/or perform the example machine-readable instructions and/or perform the example operations of FIGS. 4 and/or 5 to implement the ECU, the system controller, and/or the vehicle service system of FIGS. 1-3.

FIG. 9 is a block diagram of an example implementation of the programmable circuitry of FIG. 8.

FIG. 10 is a block diagram of another example implementation of the programmable circuitry of FIG. 8.

In general, the same reference numbers will be used throughout the drawings and accompanying written description to refer to the same or like parts. The figures are not necessarily to scale.

### DETAILED DESCRIPTION

A vehicle includes many components that contribute to its functionality. Some of those components are electronically controllable to cause those components to produce desired responses (e.g., shock absorption responses, braking responses, steering responses, engine performance responses, etc.). Some electronically controllable components are mechanically tuned to operate according to specific criteria. For example, an electronically controllable component may be manufactured as multiple different manufacturing revisions. Each of the different manufacturing revisions may be tuned to perform differently from others of the manufacturing revisions of the electronically controllable component. Manufacturing revision numbers may be identified by stampings or labels on physical surfaces of the electronically controllable components.

Multiple software tuning files to be executed by vehicle ECUs are developed to control the different manufacturing revisions of the electronically controllable component. For example, a first tuning file corresponding to a first manufacturing revision of the electronically controllable component includes a first control algorithm or first control values corresponding to a first mechanical tuning profile of the electronically controllable component of the first manufacturing revision. Additionally, a second tuning file corresponding to a second manufacturing revision of the electronically controllable component includes a second control algorithm or second control values corresponding to a second mechanical tuning profile of the electronically controllable component of the second manufacturing revision. The differences between the first and second mechanical tuning profiles of the first and second manufacturing revisions of the electronically controllable component are taken into account in differences between the control algorithms or control values in the first and second tuning files. Accordingly, different version tuning files can be generated to control electronically controllable components based on their different mechanical tunings and manufacturing revisions.

Semi-active damping systems use electronic dampers as actuators in shock absorbers of a vehicle suspension system. Damping force is a function of damper velocity and electrical current supplied by a suspension electronic control unit (ECU) to a solenoid of the electronic damper. Electronic dampers use a valve code to provide mechanical tuning flexibility within a given shock absorber. These valve codes are occasionally revised in different manufacturing revisions of shock absorbers throughout the life of a vehicle for performance purposes. The electrical current supplied to the electronic dampers is dependent on a software tuning file in the suspension ECU. That is, the ECU uses the tuning file to adjust an electrical current output based on a suspension control algorithm in the tuning file. Multiple versions of tuning files are created in association with different mechanical tunings of multiple electronic damper revisions. Prior damper implementations do not provide a way for an ECU to identify manufacturing revisions of the dampers installed in a vehicle.

To overcome limitations of prior techniques, examples disclosed herein incorporate revision-identifying circuits into electronically controllable components of a vehicle to obtain manufacturing revision numbers (e.g., manufacturing revision identifiers) of the electronically controllable components. In examples disclosed herein, ECUs of vehicles use the revision-identifying circuits to identify manufacturing revision numbers of electronically controllable components installed in the vehicles. ECUs can perform such identifying in assembly plants during manufacturing of the vehicles or in service stations during maintenance of the vehicles. As such, when a manufacturing revision of an electronically controllable component is changed in a vehicle model over the course of a manufacturing run, the ECU can detect the change and make any appropriate change to the tuning file version for the current manufacturing revision of the electronically controllable component. Similarly, when a new electronically controllable component having a different manufacturing revision is installed in a consumer-owned vehicle during routine service, the ECU can detect the change and make any appropriate change to the tuning file version for the newly installed manufacturing revision of the electronically controllable component.

To obtain manufacturing revision numbers of electronically controllable components in a vehicle, an ECU of the vehicle sends ping signals to corresponding revision-identifying circuits. The revision-identifying circuits respond to the ECU by providing corresponding response signals that the ECU can use to identify the manufacturing revision numbers of the electronically controllable components. The ECU can use the manufacturing revision numbers to identify tuning files that correspond to the electronically controllable components.

For an electronically controllable component that is a shock absorber, to identify a manufacturing revision of an electronic damper, a revision-identifying circuit is connected in parallel or in series with a solenoid of the electronic damper. The revision-identifying circuit is configured to be responsive at frequencies outside the normal operating frequency of its solenoid. As such ping signals received by the revision-identifying circuit and the solenoid from an ECU that are less than a minimum cutoff frequency or greater than a maximum cutoff frequency of the solenoid do not affect the solenoid circuit.

In some examples, the ECU can trigger sending of a ping signal (e.g., an electrical current ping signal or a voltage ping signal) to the revision-identifying circuit that is in circuit with the solenoid as part of a startup sequence or via a diagnostic routine request. In turn, the revision-identifying circuit creates a unique electrical response signal that is used by the ECU to determine a manufacturing revision number of the electronically controllable component.

In examples disclosed herein, the ECU uses the unique electrical response from the revision-identifying circuit to determine the manufacturing revision number of damper mechanical components of the shock absorber. In examples disclosed herein, the manufacturing revision number is used to determine a file identifier that may be used by an assembly plant or a service tool to flash a corresponding software tuning file into the ECU. Accordingly the ECU can use the flashed software tuning file to control the electronically controllable component in accordance with electrical control values corresponding to the manufacturing revision and mechanical tuning of that electronically controllable component.

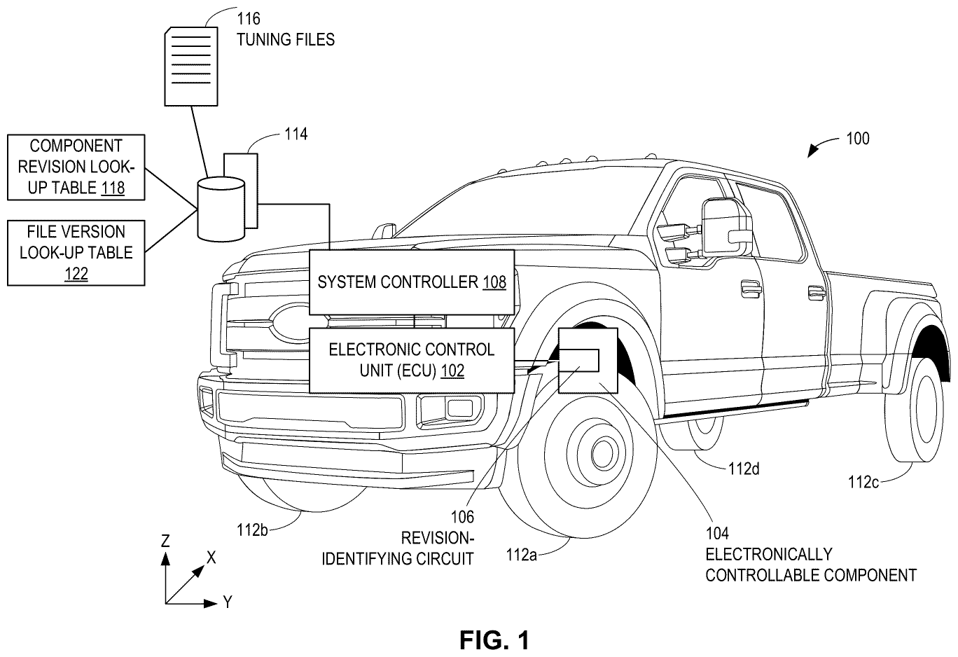

FIG. 1 is a perspective view of an example vehicle 100 in which examples disclosed herein can be implemented. In the illustrated example of FIG. 1, the vehicle 100 includes an example ECU 102, an example electronically controllable component 104, an example revision-identifying circuit 106, an example system controller 108, an example first wheel 112a, an example second wheel 112b, an example third wheel 112c, and an example fourth wheel 112d. Although the ECU 102 and the system controller 108 are shown separately in the example of FIG. 1, in other examples, the ECU 102 and the system controller 108 may be combined.

The vehicle 100 is a motorized wheel-driven vehicle. In the illustrated example of FIG. 1, the vehicle 100 is a pick-up truck. In other examples, the vehicle 100 can be any type of vehicle (e.g., a sedan, a coupe, a van, a pick-up truck, a sports utility vehicle, an all-terrain vehicle (ATV), farming equipment, etc.). The vehicle 100 may be a fully electric vehicle, a hybrid vehicle including an internal combustion engine and electrical drive components, or an internal combustion engine (e.g., a non-electrified vehicle, a partially electrified vehicle, etc.).

The wheels 112a, 112b, 112c, 112d include a wheel rim and a corresponding tire. While in the illustrated example of FIG. 1, the vehicle 100 has two axles and four wheels, in other examples, the vehicle 100 can have any number of axles and wheels. In the illustrated example of FIG. 1, the first wheel 112a and the second wheel 112b are front wheels and the third wheel 112c and the fourth wheel 112d are rear wheels. In the illustrated example of FIG. 1, the first wheel 112a and the third wheel 112c are driver-side wheels and the second wheel 112b and the fourth wheel 112d are passenger-side wheels.

The ECU 102 controls mechanical and/or electrical components in the vehicle 100 related to, for example, a suspension system, an engine, a drivetrain system, a steering system, a braking system, etc. In the illustrated example of FIG. 1, the ECU 102 is implemented using any combination of one or more programmable circuits (e.g., one or more controllers and/or processors), logic circuitry, discrete circuitry, memory, one or more interfaces, firmware, software, control data, etc.

The electronically controllable component 104 may be any type of component of the vehicle 100 that is communicatively accessible by the ECU 102. For example, the electronically controllable component 104 may be an electronic damper in a shock absorber, an electronic parking brake actuator, an electronic power steering motor, an electronic throttle body, a transmission solenoid, an electronic fuel injector, an electronic engine valve, etc. The ECU 102 may control one or more aspects of the electronically controllable component 104 to affect its functionality and functionality of the vehicle 100.

Although only the single electronically controllable component 104 is shown in FIG. 1, examples disclosed herein may be implemented with multiple electronically controllable components 104 of the same type and/or different types. For example, if the electronically controllable component 104 of FIG. 1 is a shock absorber and a corresponding electronic damper associated with the driver-side front wheel 112a, three additional electronically controllable components in the form of shock absorbers and corresponding electronic dampers are also provided in the vehicle 100 for the other wheels 112b-d. In such an example, the additional electronically controllable components include corresponding revision-identifying circuits substantially similar to the revision-identifying circuit 106. Also in such examples, the ECU 102 is in communication with those other electronically controllable components in substantially the same way as with the electronically controllable component 104.

The electronically controllable component 104 is assigned a revision number that corresponds to a manufacturing revision of that component. The manufacturing revision of the electronically controllable component 104 is associated with corresponding operating characteristics (e.g., mechanical characteristics, electrical characteristics, etc.) of the electronically controllable component 104. For example, the electronically controllable component 104 may be tuned (e.g., mechanically tuned, electrically tuned, etc.) to achieve particular actions, responses, performance, etc.

Different manufacturing revisions of the electronically controllable component 104 may be tuned differently and, thus, have different operating characteristics. To optimize performance for such different tunings and operating characteristics across different revisions of the electronically controllable component 104, the ECU 102 is provided a tuning file (e.g., a software tuning file, a firmware tuning file, control parameter values, etc.) customized for the tuning and operating characteristics corresponding to the manufacturing revision of the electronically controllable component 104 installed in the vehicle 100.

In some examples, the electronically controllable component 104 has mechanical characteristics corresponding to control parameters in the tuning file. In such examples, the electronically controllable component 104 is a mechanically tuned component having mechanical characteristics responsive to different amounts of electrical current. Examples disclosed herein may additionally or alternatively be used with electronically controllable components that are mechanically tuned to have mechanical characteristics responsive to different amounts of voltage and/or a combination of different amounts of voltage and electrical current. As such, disclosed examples that are described herein relative to using electrical currents to control electronically controllable components, such as the electronically controllable component 104, may additionally or alternatively be implemented to use electrical voltages to control such electronically controllable components. The different amounts of electrical current correspond to electrical current values obtainable by the ECU 102 using the provided tuning file. If the electronically controllable component 104 is an electronic damper in a shock absorber that is mechanically tuned to achieve a particular performance, the ECU 102 controls amounts of damping forces provided by the electronic damper based on the tuning file. For example, the ECU 102 obtains an electrical current value corresponding to an amount of damping force to be provided by the shock absorber, and based on the electrical current value, causes supply of an amount of electrical current to the electronic damper.

The revision-identifying circuit 106 is coupled to the electronically controllable component 104 to generate a revision-identifying signal indicative of the manufacturing revision of the electronically controllable component 104. The revision-identifying circuit 106 may be at least one of a resonator circuit, an oscillator circuit, or a filter circuit (e.g., a low-pass filter or a high-pass filter) that creates a response signal when it receives a signal from the ECU 102. The revision-identifying circuit 106 may be designed to include an updatable circuit component (e.g., a surface-mounted resistor, a surface-mounted capacitor, a surface-mounted inductor, etc.) to change a response profile for revision-identifying circuits incorporated into electronically controllable components of different manufacturing revisions. As such, revision-identifying circuits (e.g., the revision-identifying circuit 106) of different electrical characteristics may be incorporated into different electronically controllable components (e.g., the electronically controllable component 104) to identify respective manufacturing revision identifiers of those electronically controllable components based on unique revision-identifying signal responses from the different revision-identifying circuits.

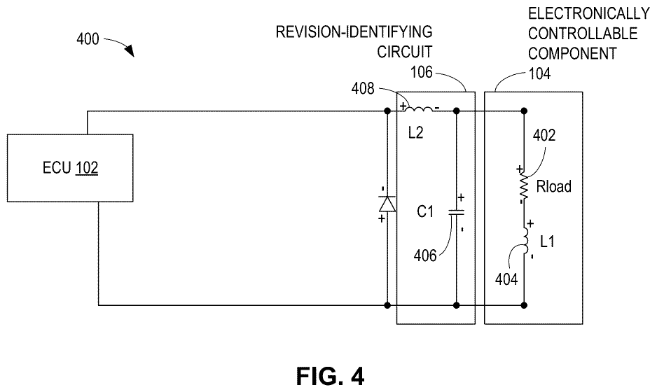

The revision-identifying circuit 106 may be in circuit with the electronically controllable component 104 so that the revision-identifying circuit 106 is communicatively accessible by the ECU 102 through the same interface that the ECU 102 connects to the electronically controllable component 104. The revision-identifying circuit 106 may be connected in parallel or in series with the electronically controllable component 104 between the ECU 102 and the electronically controllable component 104. For example, if the electronically controllable component 104 is an electronic damper of a shock absorber, the revision-identifying circuit 106 may be at least one of a resonator circuit, an oscillator circuit, or a filter circuit (e.g., a low-pass filter or a high-pass filter) that is in circuit with a solenoid of the electronic damper using a series circuit configuration or a parallel circuit configuration with the solenoid. In some examples, a parallel circuit configuration between the revision-identifying circuit 106 and the electronically controllable component 104, as described in connection with FIG. 4, may be used.

The type of revision-identifying signal generated by the revision-identifying circuit 106 to represent the manufacturing revision of the electronically controllable component 104 depends on the type of circuit used to implement the revision-identifying circuit 106. For example, the revision-identifying circuit 106 may be implemented using at least one of a resonator circuit, an oscillator signal, or a filter circuit (e.g., a low-pass filter or a high-pass filter) that responds to a received signal by generating a corresponding response signal. The response signal generated by the revision-identifying circuit 106 may be in the form of a revision-identifying signal having a particular frequency, amplitude, modulation pattern, etc. corresponding to the manufacturing revision of the electronically controllable component 104.

To cause the revision-identifying circuit 106 to generate a revision-identifying signal, the ECU 102 sends a ping signal (e.g., an electrical current signal or a voltage signal) to the revision-identifying circuit 106. In some examples, the ECU 102 may generate the ping signal during a start-up sequence of the vehicle 100 or during a diagnostic routine request. The ping signal is sensed by the revision-identifying circuit 106 because it is in circuit with the electronically controllable component 104 such that signals from the ECU 102 to the electronically controllable component 104 traverse the revision-identifying circuit 106.

In examples disclosed herein, the revision-identifying circuit 106 does not interfere with operations of the electronically controllable component 104. For example, the revision-identifying circuit 106 is responsive to ping signals from the ECU 102 at frequencies outside normal operating frequencies of the electronically controllable component 104. Accordingly, the ECU 102 generates ping signals outside a normal operating frequency or frequencies (e.g., higher or lower) of the electronically controllable component 104 so that the ping signals do not interfere with expected operation of the electronically controllable component 104. For example, the ECU 102 can send a ping signal to the revision-identifying circuit 106 that is less than a minimum cutoff frequency or greater than a maximum cutoff frequency of the electronically controllable component 104 without interfering with the operations of the electronically controllable component 104.

The ping signal interacts with the revision-identifying circuit 106 to cause the revision-identifying circuit 106 to create a unique electrical response referred to herein as a revision-identifying signal. Such unique electrical response is based on the electrical components (e.g., resistors, capacitors, inductors, oscillators, logic circuit components, etc.) of the revision-identifying circuit 106. The revision-identifying signal is a unique electrical response signal representative of the manufacturing revision of the electronically controllable component 104. As such, after the ECU 102 receives the revision-identifying signal from the revision-identifying circuit 106, the ECU 102 uses one or more signal characteristics (e.g., frequency, amplitude, modulation pattern, etc.) of the revision-identifying signal to identify the manufacturing revision of the electronically controllable component 104. In some examples, the ECU 102 translates or converts the one or more signal characteristics of the revision-identifying signal into a revision-identifying signal code corresponding to the manufacturing revision of the electronically controllable component 104. In some such examples, the revision-identifying signal code is an alphanumeric value that represents the one or more signal characteristics (e.g., a frequency value, an amplitude value, a modulation pattern value, etc.). In some examples, the ECU 102 uses the revision-identifying signal code to populate a vehicle diagnostic identifier that can be read from the ECU 102 using, for example, a vehicle diagnostics tool (e.g., a vehicle diagnostics tool connected to the vehicle service system 114).

The ECU 102 is in communication with the system controller 108 to access information external to the vehicle 100. For example, the system controller 108 may connect to an example vehicle service system 114 via wired or wireless communications during a vehicle manufacturing process, during post-sale route vehicle service, and/or during routine software updates and/or diagnostics reporting performed by the vehicle 100. In some examples, the system controller 108 communicates wirelessly (e.g., via cellular communications, Wi-Fi® communications, Bluetooth® communications, etc.) with the vehicle service system 114 when the vehicle 100 is in a service center, when the vehicle 100 is at a vehicle owner's home, when the vehicle 100 is operating, etc. Additionally or alternatively, the system controller 108 communicates via a wired connection (e.g., an Ethernet connection, an on board diagnostic (OBD) II connection, etc.) when the vehicle 100 is in a service center, at a vehicle owner's home (e.g., via a home electric vehicle (EV) charging station), at a public EV charging station, etc.

The vehicle service system 114 stores example tuning files 116, an example component revision look-up table (LUT) 118, and an example file version LUT 122. The tuning files 116 include different file versions for different manufacturing revisions of different types of electronically controllable components such as the electronically controllable component 104. For example, the tuning files 116 may include a first grouping of files having multiple file versions corresponding to different manufacturing revisions of shock absorbers, a second grouping of files having multiple file versions corresponding to different manufacturing revisions of electronic parking brake actuators, a third grouping of files having multiple file versions corresponding to different manufacturing revisions of electronic power steering motors, a fourth grouping of files having multiple file versions corresponding to different manufacturing revisions of electronic throttle bodies, a fifth grouping of files having multiple file versions corresponding to different manufacturing revisions of transmission solenoids, a sixth grouping of files having multiple file versions corresponding to different manufacturing revisions of electronic fuel injectors, a seventh grouping of files having multiple file versions corresponding to different manufacturing revisions of electronic engine valves, etc.

The different types of electronically controllable components in the vehicle 100 may be distinguished from one another based on the subsystem ECU (e.g., the ECU 102) to which they are connected. Example types of subsystem ECUs include a suspension ECU, a brake ECU, a steering ECU, a throttler ECU, a transmission ECU, an engine ECU, etc. By identifying the ECU type of the subsystem ECU from which a revision-identifying signal code is received, such identification of the subsystem ECU type can be used to identify a tuning file or a group of multi-versioned tuning files (e.g., of the tuning files 116) compatible with a corresponding type of electronically controllable component.

For example, a suspension ECU communicates with shock absorbers. As such, a revision-identifying signal code from a suspension ECU means that the revision-identifying signal code corresponds to a manufacturing revision of a shock absorber. This relationship between the revision-identifying signal code and the suspension ECU can be used to determine that a related manufacturing revision identifier corresponds to a shock absorber tuning file version in the tuning files 116.

In another example, a steering ECU communicates with an electronic power steering motor. As such, a revision-identifying signal code from a steering ECU means that the revision-identifying signal code corresponds to a manufacturing revision of an electronic power steering motor. This relationship between the revision-identifying signal code and the steering ECU can be used to determine that a related manufacturing revision identifier corresponds to a steering tuning file version in the tuning files 116.

In addition to or instead of differentiating between component types based on subsystem ECU, the different types of electronically controllable components may be distinguished from one another based on component type codes. For example, different types of electronically controllable components of the vehicle 100 may be assigned unique component type codes. In such examples, shock absorbers are assigned a first component type code that is different from a second component type code assigned to a parking brake actuator. Accordingly, a component type code can be used to identify a group of multi-versioned tuning files for a corresponding type of electronically controllable component.

For example, shock absorbers produced under five different manufacturing revisions may be assigned a component type code “SA248”. A corresponding tuning file group having five different file versions for the shock absorbers may be grouped by the component type code “SA248”. In this example, each of the five different manufacturing revisions of the “SA248” shock absorbers corresponds to a respective one of the tuning file versions in the tuning file group. An example naming convention for the tuning file versions may be: “SA248_T_File_version1.bin”, “SA248_T_File_version2.bin”, “SA248_T_File_version3.bin”, “SA248_T_File_version4.bin”, and “SA248_T_File_version5.bin”.

To generate electrical current-based control signals (and/or voltage-based control signals), a corresponding tuning file 116 may include a component-control look-up table (LUT) of electrical current values (and/or voltage values) stored in association with corresponding mechanical responses (e.g., mechanical actions) to be generated by electronically controllable components such as the electronically controllable component 104. Additionally or alternatively, the tuning file 116 may include machine-readable instructions defining a machine-executable routine (e.g., a control algorithm) to determine (e.g., calculate, look up, retrieve, etc.) electrical current values (and/or voltage values) corresponding to desired mechanical responses. Example mechanical responses, or mechanical actions, include forces, angular rotations, linear travel lengths, etc.

Desired mechanical responses may be obtained from human operators of the vehicle 100 through, for example, braking input, steering maneuvers, throttle input, etc. Desired mechanical responses may also be obtained from automated vehicle processes such as a stability control process, an automated vehicle control system, a vehicle performance process, etc. The ECU 102 may retrieve or determine an electrical current value (and/or voltage value) based on the tuning file 116 and based on a corresponding mechanical response that is to be generated by the electronically controllable component 104. The ECU 102 uses the electrical current value (and/or voltage value) to cause an electrical current driver circuit (and/or voltage driver circuit) to provide a corresponding amount of electrical current (and/or voltage) to the electronically controllable component 104. Based on that electrical current (and/or voltage) input to the electronically controllable component 104, the electronically controllable component 104 generates or provides the desired corresponding mechanical response.

For example, for an electronic damper of a shock absorber, a component-control LUT in the tuning file 116 may store multiple electrical current values (and/or voltage values) in association with force values representative of amounts of forces to be provided by the shock absorber. In such an example, the electrical current values (and/or voltage values) represent amounts of electrical current (and/or amounts of voltage) to be generated by an electrical current driver circuit (and/or a voltage driver circuit) and supplied to the electronic damper to cause the shock absorber to provide the corresponding forces in the component-control LUT in the tuning file 116.

In some examples in which the electronically controllable component 104 provides forces associated with operation of the vehicle 100, a first file version of a tuning file 116 corresponds to the electronically controllable component 104 having a first manufacturing revision identifier and specifies a first amount of electrical current (and/or first amount of voltage) to cause the first revision of the electronically controllable component 104 to provide a particular force. In such examples, the first amount of electrical current (and/or the first amount of voltage) is different from a second amount of electrical current (and/or second amount of voltage) specified by a second file version of the tuning file 116 corresponding to a second electronically controllable component having a second manufacturing revision identifier. The second manufacturing revision identifier is different from the first manufacturing revision identifier of the electronically controllable component 104. In addition, the second amount of electrical current (and/or the second amount of voltage) is to cause the second electronically controllable component to provide the same force as provided by the electronically controllable component 104 based on the first amount of electrical current (and/or the first amount of voltage). The differing control signals between the electronically controllable component 104 and the second electronically controllable component are based on the different mechanically tuned characteristics of those components. That is, the different mechanically tuned characteristics cause the different revisions of the electronically controllable component 104 and the second electronically controllable component to react the same way based on different amounts of input electrical current (and/or voltage).

The component revision LUT 118 is provided to store manufacturing revision identifiers (e.g., manufacturing revision numbers) for different electronically controllable components in association with revision-identifying signal codes corresponding to revision-identifying signal responses from revision-identifying circuitry such as the revision-identifying circuit 106. For example, a revision-identifying signal code is mapped in the component revision LUT 118 as corresponding to the manufacturing revision of the electronically controllable component 104 to which the revision-identifying circuit 106 is coupled.

The file version LUT 122 is provided to store file identifiers (e.g., file names, file numbers, file memory address locations, etc.) of different versions of the tuning files 116 in association with corresponding manufacturing revision identifiers. In some examples, the file version LUT 122 stores the file identifier in association with manufacturing revision identifiers and at least one of component type codes (e.g., “SA248” for shock absorbers) or ECU type codes for different electronically controllable components. For example, the manufacturing revision identifier, or a pairing of the manufacturing revision identifier and at least one of the component type code or the ECU type code corresponding to the electronically controllable component 104, can be stored in the file version LUT 122 in association with a file identifier of the tunning file 116 that is to be used by the ECU 102 to control the electronically controllable component 104.

The file identifiers (e.g., file names, file numbers, file memory address locations, etc.) stored in the file version LUT 122 distinguish between different versions of the tuning files 116 for different electronically controllable components. For example, for a shock absorber having a component type code of “SA248”, a file identifier in the file version LUT 122 may be “SA248_T_File_version1.bin” which corresponds to version one of a tuning file for the shock absorber. In some examples, this version one tuning file may be for a single manufacturing revision (e.g., manufacturing revision “001”) of the shock absorber or for multiple manufacturing revisions (e.g., manufacturing revisions “001”- “003”) of the shock absorber.

When the vehicle service system 114 receives a revision-identifying signal code and at least one of a component type code or an ECU type code from the system controller 108 of the vehicle 100 that corresponds to the electronically controllable component 104, the vehicle service system 114 uses the revision-identifying signal code to look up and obtain a manufacturing revision number in the component revision LUT 118. The vehicle service system 114 then uses the manufacturing revision number and the at least one of the component type code or the ECU type code to look up and obtain a file identifier in the file version LUT 122. In some examples, the component type code and/or the ECU type code is a base part number or file name that identifies a corresponding tuning file or group of multi-versioned tuning files in the tuning files 116. The vehicle service system 114 retrieves a tuning file 116 that is for the electronically controllable component 104 and has a file version corresponding to the file identifier obtained from the file version LUT 122. The vehicle service system 114 sends the retrieved tuning file 116 to the system controller 108 so that the tuning file 116 can be used by the ECU 102 to control the electronically controllable component 104.

In some examples, the tuning file(s) 116, the component revision LUT 118, and the file version LUT 122 are stored in the ECU 102.

For example, the vehicle service system 114 may download these items to the vehicle 100 via the system controller 108 during a manufacturing process and provide post-manufacturing updates to the vehicle 100 via wired or wireless communications. In such examples, after the ECU 102 determines a revision-identifying signal code based on a revision-identifying signal from the revision-identifying circuit 106, the ECU 102 uses the revision-identifying signal code to obtain a manufacturing revision from the component revision LUT 118 in the ECU 102, and uses the manufacturing revision to obtain a file identifier from the file version LUT 122 in the ECU 102 as described above. The ECU 102 then uses the file identifier to select or enable a corresponding one of the tuning file(s) 116 in the ECU 102 to control the electronically controllable component 104.

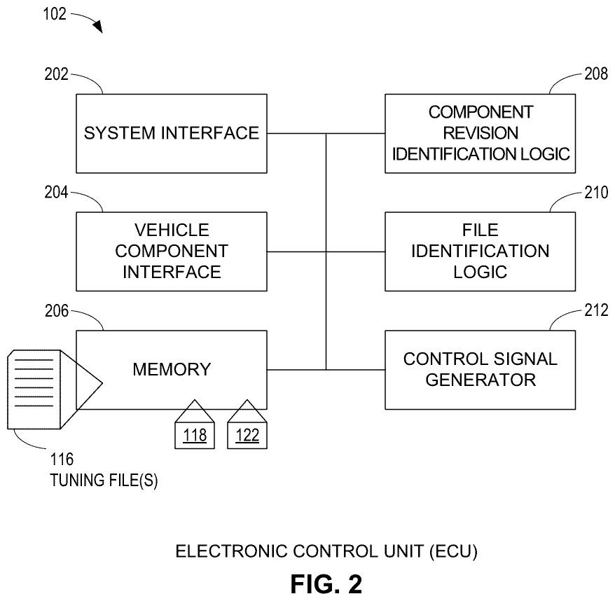

FIG. 2 is a block diagram of an example implementation of the ECU 102 of FIG. 1 to determine manufacturing revisions of electronically controllable components (e.g., the electronically controllable component 104 of FIG. 1) and obtain corresponding versions of tuning files (e.g., the tuning files 116 of FIG. 1) to control the electronically controllable components. The ECU 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the ECU 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

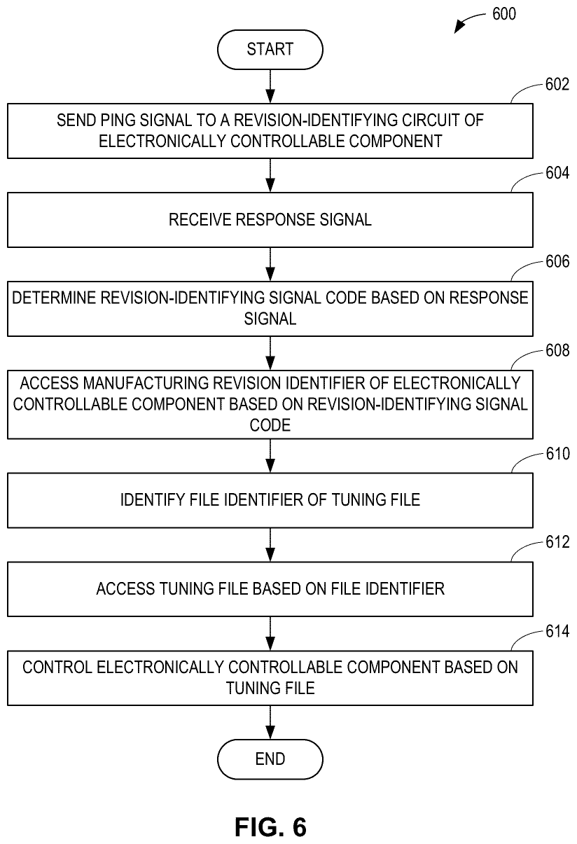

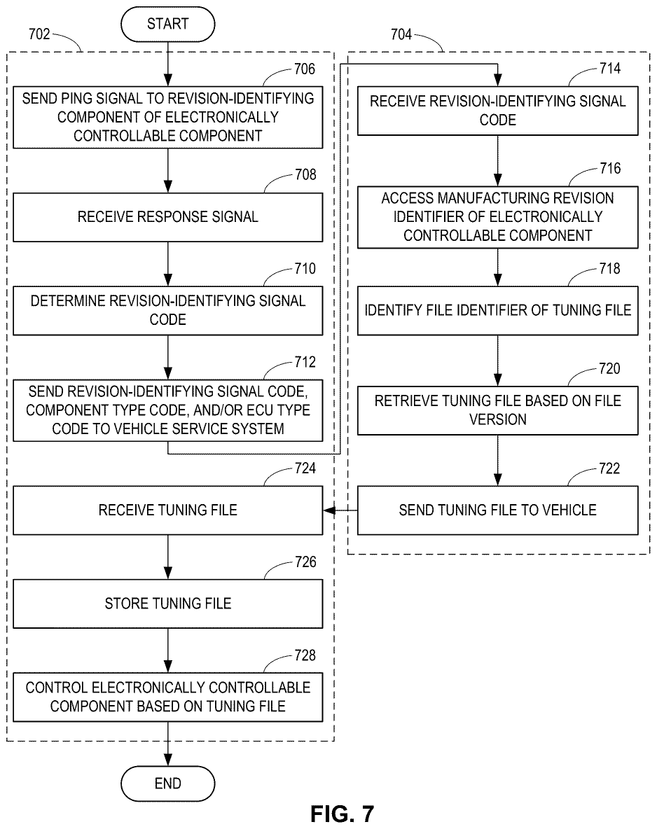

In the example of FIG. 2, the ECU 102 includes an example system interface 202, an example vehicle component interface 204, an example memory 206, example component revision identification logic 208, example file identification logic 210, and an example control signal generator 212. The system interface 202 is provided to communicate with the system controller 108 (FIG. 1). For example, the system interface 202 can receive multiple ones of the tuning files 116 from the vehicle service system 114 via the system controller 108. In other examples, the system interface 202 sends a revision-identifying signal code and at least one of a component type code or an ECU type code to the vehicle service system 114 via the system controller 108 and receives a corresponding tuning file 116 from the vehicle service system 114. In some examples, the system interface 202 includes a flashing interface that flashes the tuning file(s) 116 in the memory 206. In some examples, the system interface 202 is implemented as system interface circuitry. In some examples, such system interface circuitry is instantiated by programmable circuitry executing system interface instructions and/or configured to perform operations such as those represented by the flowchart(s) of FIG. 6 and/or FIG. 7.

The vehicle component interface 204 is provided to communicate with the electronically controllable component 104 and the revision-identifying circuit 106 of FIG. 1. In some examples, the vehicle component interface 204 is implemented as vehicle component interface circuitry. In some examples, such vehicle component interface circuity is instantiated by programmable circuitry executing vehicle component interface instructions and/or configured to perform operations such as those represented by the flowchart(s) of FIG. 6 and/or FIG. 7.

The memory 206 is provided to store machine-readable instructions and/or data. For example, the memory 206 stores one or more tuning file(s) 116 obtained from the vehicle service system 114 (FIG. 1). In some examples, the memory 206 stores a plurality of tuning files 116 (e.g., corresponding to multiple manufacturing revisions of different types of electronically controllable components), the component revision LUT 118, and the file version LUT 122.

The component revision identification logic 208 is provided to determine manufacturing revision identifiers of electronically controllable components (e.g., the electronically controllable component 104 of FIG. 1). The component revision identification logic 208 may determine manufacturing revision identifiers using any suitable technique including example techniques described above in connection with FIG. 1. In some examples, the component revision identification logic 208 is implemented as component revision identification logic circuitry. In some examples, such component revision identification logic circuitry is instantiated by programmable circuitry executing component revision identification instructions and/or configured to perform operations such as those represented by the flowchart(s) of FIG. 6 and/or FIG. 7.

The file identification logic 210 is provided to determine file identifiers of the tuning files 116 corresponding to manufacturing revision identifiers of electronically controllable components (e.g., the electronically controllable component 104). The file identification logic 210 may determine file identifiers using any suitable technique including example techniques described above in connection with FIG. 1. In some examples, the file identification logic 210 is implemented as file identification logic circuitry. In some examples, such file identification logic circuitry is instantiated by programmable circuitry executing file identification instructions and/or configured to perform operations such as those represented by the flowchart(s) of FIG. 6 and/or FIG. 7.

The control signal generator 212 is provided to generate control signals (e.g., electrical current control signals and/or voltage control signals) based on ones of the tuning files 116 to control corresponding electronically controllable components (e.g., the electronically controllable component 104). For example, the control signal generator 212 may look up a desired mechanical response in a component-control LUT of a tuning file 116 to retrieve an electrical current value (and/or voltage value) to cause a corresponding electronically controllable component 104 to generate or provide the desired mechanical response. Alternatively, the control signal generator 212 may execute machine-readable instructions in the tuning file 116 to perform a software/firmware routine (e.g., a control algorithm) to determine (e.g., calculate, look up, retrieve, etc.) an electrical current value (and/or voltage value) based on the desired mechanical response that is to be provided by the electronically controllable component 104.

In any case, the control signal generator 212 uses the determined electrical current value (and/or voltage value) to cause an electrical current drive circuit (and/or a voltage drive circuit) to generate and provide a corresponding amount of electrical current (and/or a corresponding amount of voltage) to the electronically controllable component 104. In response to receipt of the generated electrical current (and/or voltage), the electronically controllable component 104 generates or provides the desired mechanical response. In some examples, the control signal generator 212 is implemented as control signal generator circuitry. In some examples, such control signal generator circuitry is instantiated by programmable circuitry executing control signal generator instructions and/or configured to perform operations such as those represented by the flowchart(s) of FIG. 6 and/or FIG. 7.

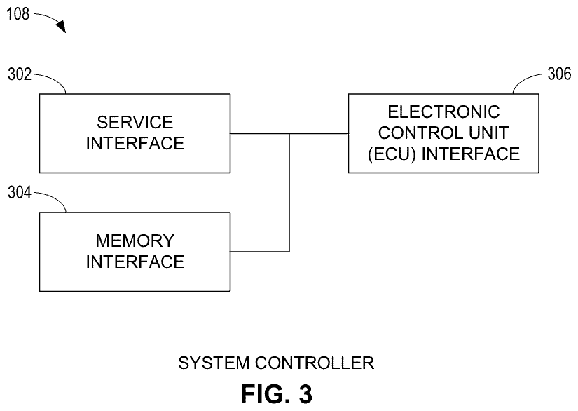

FIG. 3 is a block diagram of an example implementation of the system controller 108 of FIG. 1 to communicate with the ECU 102 and the vehicle service system 114 of FIG. 1. The system controller 108 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the system controller 108 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In the example of FIG. 3, the system controller 108 includes an example service interface 302, an example memory interface 304, and an example ECU interface 306. The service interface 302 is provided to communicate with the vehicle service system 114 of FIG. 1. In some examples, the service interface 302 is implemented as service interface circuitry. In some examples, the service interface circuitry is instantiated by programmable circuitry executing service interface instructions and/or configured to perform operations such as those represented by the flowchart(s) of FIG. 6 and/or FIG. 7.

The memory interface 304 is provided to access memory in the system controller 108 or external to the system controller 108 but in the vehicle 100. For example, the vehicle 100 may include volatile memory (e.g., dynamic random access memory (DRAM), static RAM (SRAM), etc.) and/or non-volatile memory (e.g., read only memory (ROM), flash memory, a solid-state drive (SSD), etc.). In such examples, the memory interface 304 accesses such memory to read machine-readable instructions, files, data, etc. stored therein. In some examples, the memory interface 304 uses such memory as temporary storage space such as when downloading one or more of the tuning files 116, the component revision LUT 118, and/or the file version LUT 122 from the vehicle service system 114 to load into the ECU 102. In some examples, the memory interface 304 is implemented as memory interface circuitry. In some examples, such memory interface circuitry is instantiated by programmable circuitry executing memory interface instructions and/or configured to perform operations such as those represented by the flowchart(s) of FIG. 6 and/or FIG. 7.

The ECU interface 306 is provided to communicate with the ECU 102. In some examples, the ECU interface 306 is implemented as ECU interface circuitry. In some examples, such ECU interface circuitry is instantiated by programmable circuitry executing ECU interface instructions and/or configured to perform operations such as those represented by the flowchart(s) of FIG. 6 and/or FIG. 7.

As described above, the system interface 202, the vehicle component interface 204, the memory 206, the component revision identification logic 208, the file identification logic 210, the control signal generator 212, and/or more generally the ECU 102 of FIG. 2 and the service interface 302, the memory interface 304, the ECU interface 306, and/or more generally the system controller 108 of FIG. 3 are structures. Such structures may implement means for performing corresponding disclosed functions. Examples of such functions are described above in connection with corresponding ones of the system interface 202, the vehicle component interface 204, the memory 206, the component revision identification logic 208, the file identification logic 210, the control signal generator 212, the service interface 302, the memory interface 304, the ECU interface 306, and/or more generally the ECU 102 and the system controller 108 and are described below in connection with the flowchart(s) of FIG. 6 and/or FIG. 7.

While example manners of implementing the ECU 102 and the system controller 108 of FIG. 1 are illustrated in FIGS. 2 and 3, one or more of the elements, processes, and/or devices illustrated in FIGS. 2 and 3 may be combined, divided, re-arranged, omitted, eliminated, and/or implemented in any other way. Further, the system interface 202, the vehicle component interface 204, the memory 206, the component revision identification logic 208, the file identification logic 210, the control signal generator 212, the service interface 302, the memory interface 304, the ECU interface 306, and/or more generally the ECU 102 and the system controller 108 of FIGS. 2 and 3, may be implemented by hardware alone or by hardware in combination with software and/or firmware. Thus, for example, any of the system interface 202, the vehicle component interface 204, the memory 206, the component revision identification logic 208, the file identification logic 210, the control signal generator 212, the service interface 302, the memory interface 304, the ECU interface 306, and/or, more generally, the example ECU 102 and/or the example system controller 108, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example ECU 102 and the system controller 108 of FIGS. 2 and 3 may include one or more elements, processes, and/or devices in addition to, or instead of, those illustrated in FIGS. 2 and 3, and/or may include more than one of any or all of the illustrated elements, processes and devices.

FIG. 4 is a schematic diagram of example implementations of the electronically controllable component 104 and the revision-identifying circuit 106 of FIG. 1. In FIG. 4, the electronically controllable component 104 is represented by way of example as a load (Rload) 402 in series with an inductor (L1) 404. The electronically controllable component 104 may be represented and/or implemented any other way. In FIG. 4, the revision-identifying circuit 106 is implemented by way of example as a low-pass filter that includes an example capacitor (C1) 406 and an example inductor (L2) 408. However, the example low-pass filter may be implemented using any other suitable circuit configuration. In the example of FIG. 4, the revision-identifying circuit 106 is connected in parallel with the electronically controllable component 104. However, as noted above, the revision-identifying circuit 106 may alternatively be connected in series with the electronically controllable component 104.

Selections of capacitance value of the capacitor (C1) 406 and of inductance value of the inductor (L2) 408 create a corresponding cutoff frequency for the low-pass filter configuration of the revision-identifying circuit 106. Accordingly, to create different revision-identifying signal responses that correspond to different manufacturing revisions of electronically controllable components, the revision-identifying circuit 106 can be modified by changing one or both of the capacitance value of the capacitor (C1) 406 and the induction value of the inductor (L2) 408. For example, a first capacitance value of the capacitor (C1) 406 can be used in a first revision-identifying circuit design to create a first cutoff frequency to identify a first manufacturing revision and a second capacitance value of the capacitor (C1) 406 can be used in a second revision-identifying circuit design to create a second cutoff frequency to identify a second manufacturing revision. Similarly, the induction value of the inductor (L2) 408 could be changed in addition to or instead of the capacitance value of the capacitor (C1) 406 to create different cutoff frequencies. By selecting different values for the capacitor (C1) 406 and/or the inductor (L2) 408, the revision-identifying circuit 106 can be used to represent different manufacturing revisions of the electronically controllable component 104.

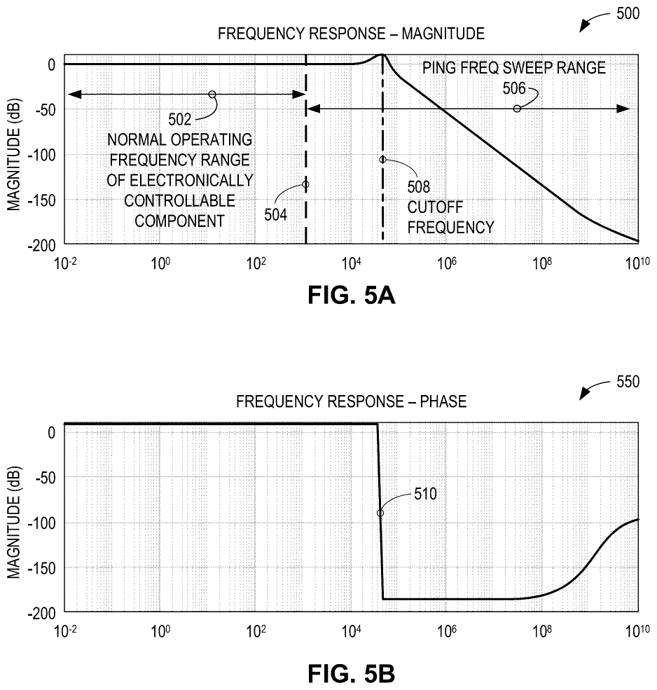

FIG. 5A is an example magnitude-based frequency response graph 500 and FIG. 5B is an example phase-based frequency response graph 550 of the example low-pass filter implementation of FIG. 4 of the revision-identifying circuit 106 of FIGS. 1 and 4. The magnitude-based frequency response graph 500 shows an example normal operating frequency range 502 of the electronically controllable component 104 that includes frequencies below an upper operating frequency threshold 504. The magnitude-based frequency response graph 500 also shows an example ping frequency sweep range 506 that includes frequencies above the upper operating frequency threshold 504.

Signals received by the electronically controllable component 104 having frequencies in the normal operating frequency range 502 (e.g., at or below the upper operating frequency threshold 504) cause the electronically controllable component 104 to create a responsive action (e.g., generate a force, generate a rotation, etc.). Signals received by the electronically controllable component 104 having frequencies in the ping frequency sweep range 506 (e.g., above the upper operating frequency threshold 504) do not cause a responsive action by the electronically controllable component 104 (e.g., are ignored by the electronically controllable component 104).

The low-pass filter implementation of the revision-identifying circuit 106 of FIG. 4 can be designed to have different cutoff frequencies in the ping frequency sweep range above the upper operating frequency threshold 504 to identify different manufacturing revisions. In the example of FIG. 5A, an example cutoff frequency 508 of the low-pass filter is set above the upper operating frequency threshold 504 of the electronically controllable component 104 so that ping signals from the ECU 102 do not interfere with operation of the electronically controllable component 104. For example, the cutoff frequency 508 is selected at a point in the ping frequency sweep range 506 at which signals have no effect on the electronically controllable component 104. This is shown by a signal attenuation in magnitude starting at the cutoff frequency 508 in the magnitude-based frequency response graph 500 and is also shown by an example phase shift 510 in the phase-based frequency response graph 550.

During a revision identification phase, the ECU 102 performs a frequency sweep by sending multiple ping signals at different frequencies in the ping frequency sweep range (e.g., frequencies greater than the upper operating frequency threshold 504) to the electronically controllable component 104 and the revision-identifying circuit 106 to identify a manufacturing revision of the electronically controllable component 104. During this frequency sweep, the ECU 102 monitors response signals from the revision-identifying circuit 106 to detect at which frequency the response signals begin to be attenuated.

In the example of FIG. 5A, the start of signal attenuation begins at the cutoff frequency 508. As described above, the cutoff frequency 508 of the low-pass filter implementation of the revision-identifying circuit 106 depends on the capacitance of the capacitor (C1) 406 and/or the inductance of the inductor (L2) 408. To identify a different manufacturing revision based on a different frequency, the cutoff frequency 508 can be shifted left or right on the magnitude-based frequency response graph 500 by changing one or both of the capacitance of the capacitor (C1) 406 and/or the inductance of the inductor (L2) 408. Accordingly, different unique cutoff frequencies can be created based on the example low-pass filter implementation of the revision-identifying circuit 106 of FIG. 4 to identify different manufacturing revisions of the electronically controllable component 104.

Although the example implementation of the revision-identifying circuit 106 is described as a low-pass filter in connection with FIGS. 4, 5A, and 5B, the revision-identifying circuit 106 can be implemented using any other suitable type of circuit that can be modified to create different signal responses for corresponding manufacturing revisions. In addition, although a cutoff frequency characteristic is described in connection with FIG. 5A, any other suitable type of signal characteristic may be used to differentiate between different manufacturing revisions. For example, the revision-identifying circuit 106 may additionally or alternatively be implemented using a resonator circuit, an oscillator circuit, a high-pass filter circuit, etc. and the ECU 102 may use any suitable signal characteristic(s) of response signals such as frequency, amplitude, modulation pattern, etc. to identify manufacturing revisions.

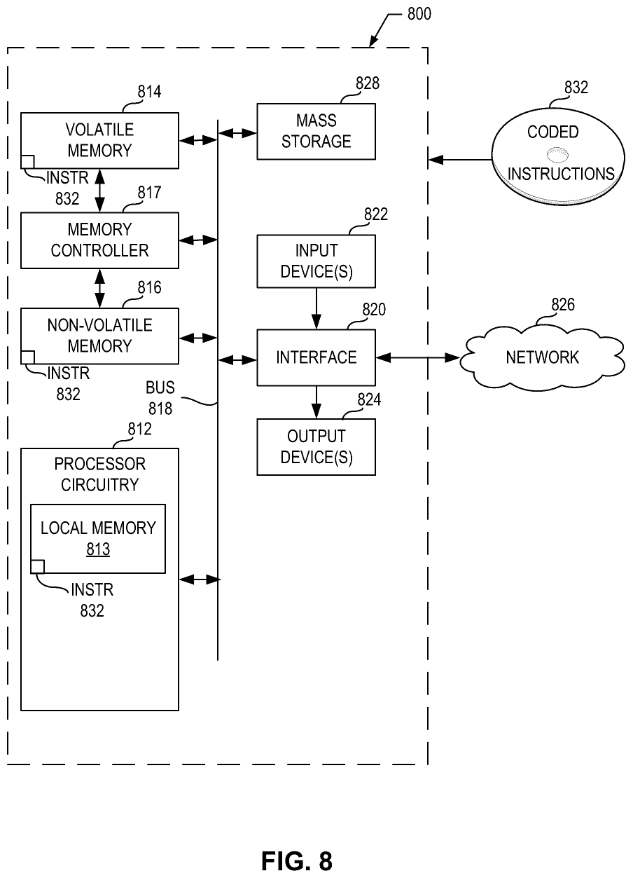

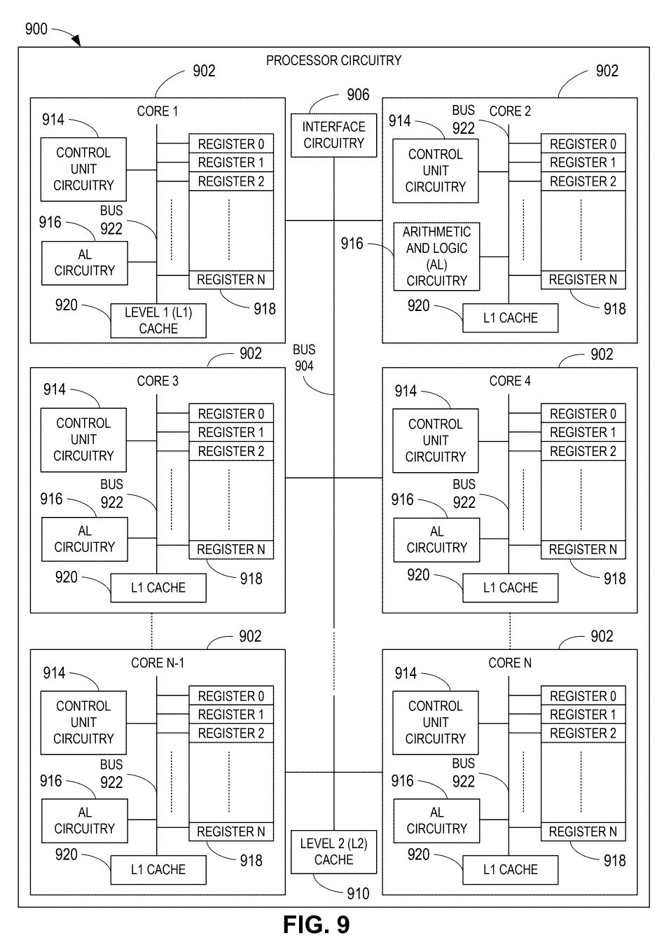

Flowchart(s) representative of example machine-readable instructions, which may be executed by programmable circuitry to implement and/or instantiate the ECU 102, the system controller 108, and/or the vehicle service system 114 of FIGS. 1-3 and/or representative of example operations which may be performed by programmable circuitry to implement and/or instantiate the ECU 102, the system controller 108, and/or the vehicle service system 114 of FIGS. 1-3, are shown in FIGS. 4 and/or 5. The machine-readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 4 and/or 5, many other methods of implementing the ECU 102, the system controller 108, and/or the vehicle service system 114 of FIGS. 1-3 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4 and/or 5 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices /d/ or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 6 is a flowchart representative of example machine-readable instructions and/or example operations 600 that may be executed, instantiated, and/or performed by example programmable circuitry to implement the ECU 102 of FIGS. 1 and 2 to determine manufacturing revisions of electronically controllable components (e.g., the electronically controllable component 104 of FIG. 1) and obtain corresponding versions of tuning files (e.g., the tuning files 116 of FIG. 1) to control the electronically controllable components. The example machine-readable instructions and/or the example operations 600 of FIG. 6 begin at block 602, at which the vehicle component interface 204 (FIG. 2) sends a ping signal to a revision-identifying circuit of a target electronically controllable component. For example, the vehicle component interface 204 sends the ping signal to the revision-identifying circuit 106 (FIG. 1) of the electronically controllable component 104. At block 604, the vehicle component interface 204 receives a response signal from the revision-identifying circuit 106. For example, the vehicle component interface 204 receives a revision-identifying signal corresponding to a manufacturing revision identifier of the electronically controllable component 104.

At block 606, the vehicle component interface 204 determines a revision-identifying signal code based on the response signal obtained at block 604. For example, the vehicle component interface 204 may generate an alphanumeric value representative of one or more signal characteristics (e.g., frequency, amplitude, modulation pattern, etc.) of the revision-identifying signal received from the revision-identifying circuit 106. At block 608, the component revision identification logic 208 (FIG. 2) accesses a manufacturing revision identifier of the electronically controllable component 104 based on the revision-identifying signal code. For example, the component revision identification logic 208 accesses the component revision LUT 118 in the memory 206 (FIG. 2) based on the revision-identifying signal code to retrieve the manufacturing revision identifier that is stored in association with the revision-identifying signal code.

At block 610, the file identification logic 210 (FIG. 2) identifies a file identifier of a tuning file 116. For example, the file identification logic 210 accesses the file version LUT 122 in the memory 206 based on the manufacturing revision identifier obtained at block 608 to retrieve the file identifier that is stored in association with the manufacturing revision identifier. In some examples, the file identification logic 210 also uses at least one of a component type code or an ECU type code corresponding to the electronically controllable component 104 to retrieve the file identifier from the file version LUT 122. As described above, the file identifier is representative of a version of a tuning file 116 that is to be used to electronically control the electronically controllable component 104 associated with the identified manufacturing revision.

At block 612, the control signal generator 212 (FIG. 2) accesses a tuning file 116 based on the file identifier identified at block 610. For example, the control signal generator 212 accesses the tuning file 116 in the memory 206 corresponding to the file identifier for the manufacturing revision identifier of the electronically controllable component 104. In some examples, the control signal generator 212 selects, or accesses, the tuning file 116 from multiple other tuning files 116 stored in the memory 206. In such examples, the multiple tuning files 116 have different tuning file versions corresponding to different manufacturing revisions of the electronically controllable component 104. The control signal generator 212 enables or activates the selected tuning file 116 as corresponding to the manufacturing revision identifier from block 608 for the electronically controllable component 104. Such enabling or activating may be in the form of loading control parameter values and/or machine-readable instructions in an area of the memory 206 allocated for control of the electronically controllable component 104.

At block 614, the control signal generator 212 controls the electronically controllable component 104 based on the tuning file 116. For example, the control signal generator 212 obtains a desired mechanical response to be provided or generated by the electronically controllable component 104 and obtains a corresponding electrical current value (and/or voltage value) from the tuning file 116 based on the desired mechanical response. The control signal generator 212 then generates a control signal based on the electrical current value (and/or the voltage value). The control signal causes an electrical current drive circuit (and/or a voltage drive circuit) to generate and provide a corresponding amount of electrical current (and/or amount of voltage) to the electronically controllable component 104. The instructions and/or operations 600 of FIG. 6 end.

FIG. 7 is a flowchart representative of example machine-readable instructions and/or example operations 700 that may be executed, instantiated, and/or performed by example programmable circuitry to implement the ECU 102 and the vehicle service system 114 of FIGS. 1-3. The instructions and/or operations 700 are grouped into two example processes that include an example ECU process 702 and an example vehicle service system process 704. The ECU process 702 is performed by the ECU 102. The vehicle service system process 704 is performed by the vehicle service system 114.

The example machine-readable instructions and/or the example operations 700 of FIG. 7 begin at block 706 of the ECU process 702, at which the vehicle component interface 204 (FIG. 2) sends a ping signal to a revision-identifying circuit of a target electronically controllable component. For example, the vehicle component interface 204 sends the ping signal to the revision-identifying circuit 106 (FIG. 1) of the electronically controllable component 104. At block 708, the vehicle component interface 204 receives a response signal from the revision-identifying circuit 106. For example, the vehicle component interface 204 receives a revision-identifying signal corresponding to a manufacturing revision identifier of the electronically controllable component 104.

At block 710, the vehicle component interface 204 determines a revision-identifying signal code. For example, the vehicle component interface 204 determines the revision-identifying signal code based on the response signal obtained at block 708. The vehicle component interface 204 may generate an alphanumeric value representative of one or more signal characteristics (e.g., frequency, amplitude, modulation pattern, etc.) of the revision-identifying signal received from the revision-identifying circuit 106.

At block 712, the system interface 202 (FIG. 2) sends the revision-identifying signal code and at least one of a component type code or an ECU type code corresponding to the electronically controllable component 104 to the vehicle service system 114. In some examples, the system interface 202 sends the revision-identifying signal code and the at least one of the component type code or the ECU type code to the vehicle service system 114 via the system controller 108 (FIGS. 1 and 3). In other examples, the system interface 202 sends the revision-identifying signal code and the at least one of the component type code or the ECU type code directly to the vehicle service system 114 via wired or wireless communications.

Turning now to the vehicle service system process 704, at block 714, the vehicle service system 114 receives the revision-identifying signal code provided by the ECU 102. At block 716, the vehicle service system 114 accesses a manufacturing revision identifier of the electronically controllable component 104 based on the revision-identifying signal code. For example, the vehicle service system 114 accesses the component revision LUT 118 (FIG. 1) based on the revision-identifying signal code to retrieve the manufacturing revision identifier that is stored in association with the revision-identifying signal code.

At block 718, the vehicle service system 114 identifies a file identifier of a tuning file 116. For example, the vehicle service system 114 accesses the file version LUT 122 based on the manufacturing revision identifier obtained at block 716 and at least one of a component type code or an ECU type code corresponding to the electronically controllable component 104 to retrieve the file identifier that is stored in association with the manufacturing revision identifier and the at least one of the component type code or the ECU type code. As described above, the file identifier is representative of a version of a tuning file 116 that is to be used to electronically control the electronically controllable component 104 associated with the identified manufacturing revision.

At block 720, the vehicle service system 114 retrieves a tuning file 116 based on the file identifier identified at block 718. For example, the vehicle service system 114 retrieves the tuning file 116 corresponding to the file identifier for the manufacturing revision identifier of the electronically controllable component 104.

At block 722, the vehicle service system 114 sends the tuning file 116 to the ECU 102. In some examples, the vehicle service system 114 sends the tuning file 116 to the ECU 102 via the system controller 108 in the vehicle 100. In other examples, the vehicle service system 114 sends the tuning file 116 directly to the ECU 102.

Returning to the ECU process 702, at block 724, the system interface 202 receives the tuning file 116. At block 726, the memory 206 (FIG. 2) stores the tuning file 116. For example, the system interface 202 can flash the tuning file 116 in the memory 206 of the ECU 102. At block 728, the control signal generator 212 (FIG. 2) controls the electronically controllable component 104 based on the tuning file 116. For example, the control signal generator 212 obtains a desired mechanical response to be provided or generated by the electronically controllable component 104 and obtains a corresponding electrical current value (and/or voltage value) from the tuning file 116 corresponding to the desired mechanical response. The control signal generator 212 then generates a control signal based on the electrical current value (and/or the voltage value). The control signal causes an electrical current drive circuit (and/or a voltage drive circuit) to generate and provide a corresponding amount of electrical current (and/or amount of voltage) to the electronically controllable component 104. The instructions and/or operations 700 of FIG. 7 end.

FIG. 8 is a block diagram of an example programmable circuitry platform 800 structured to execute and/or instantiate the example machine-readable instructions and/or the example operations of FIGS. 4 and/or 5 to implement the ECU 102, the system controller 108, and/or the vehicle service system 114 of FIGS. 1-3. The programmable circuitry platform 800 can be, for example, a server, a computer, a workstation, a self-learning machine (e.g., a neural network), or any other type of computing and/or electronic device that implements the vehicle service system 114 of FIG. 1. In some examples, the programmable circuitry platform 800 can be, for example, the ECU 102 and/or the system controller 108 of FIGS. 1-3.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In examples in which the programmable circuitry platform 800 implements the ECU 102, the programmable circuitry 812 implements the component revision identification logic 208, the file identification logic 210, and the control signal generator 212.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816. In examples in which the programmable circuitry platform 800 implements the ECU 102, one or both of the memories 814, 816 implement(s) the memory 206 of FIG. 2.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In examples in which the programmable circuitry platform 800 implements the ECU 102, the interface circuitry 820 implements the system interface 202 and/or the vehicle component interface 204 of FIG. 2. In examples in which the programmable circuitry platform 800 implements the system controller 108, the interface circuitry 820 implements the service interface 302, the memory interface 304, and/or the ECU interface 306.

In the illustrated example, one or more input devices 822 are connected to the interface circuitry 820. The input device(s) 822 permit(s) a user (e.g., a human user, a machine user, etc.) to enter data and/or commands into the programmable circuitry 812.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), an in-place switching (IPS) display, a touchscreen, etc.), a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 4 and/or 5, may be stored in the mass storage device 828, in the volatile memory 814, in the non-volatile memory 816, and/or on at least one non-transitory computer-readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 4 and/or 5 to effectively instantiate the circuitry of FIGS. 2 and 3 as logic circuits to perform operations corresponding to those machine-readable instructions. In some such examples, the circuitry of FIGS. 2 and 3 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 4 and/or 5.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

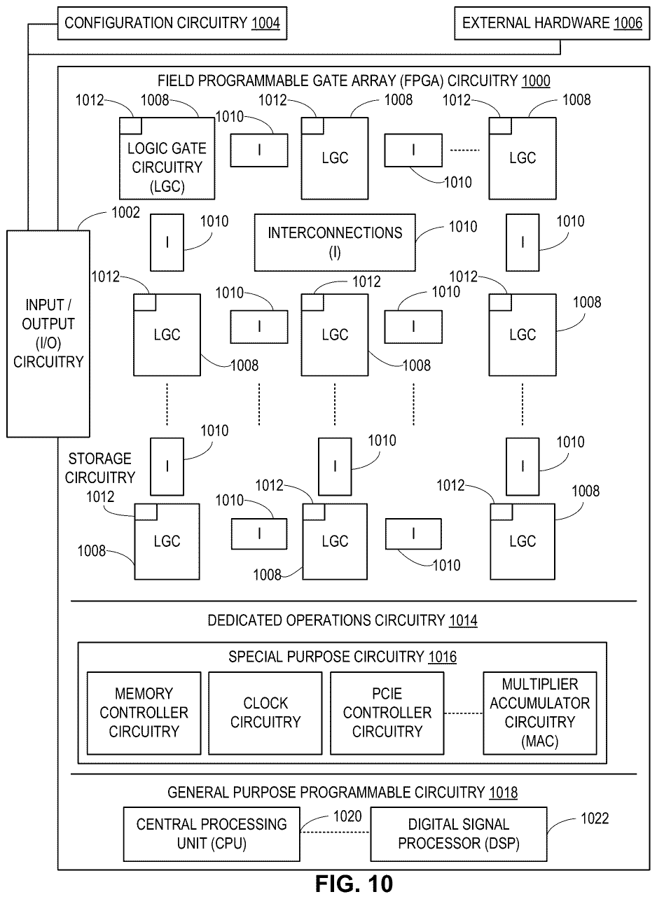

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 4 and/or 5 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 4 and/or 5. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and/or 5. As such, the FPGA circuitry 1000 may be configured and/or structured to effectively instantiate some or all of the operations/functions corresponding to the machine-readable instructions of the flowchart(s) of FIGS. 4 and/or 5 as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 4 and/or 5 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 4 and/or 5 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops, etc.), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to substantially reduce or eliminate the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 4 and/or 5 to perform first operation(s)/function(s), the FPGA circuitry 1000 of FIG. 10 may be configured and/or structured to perform second operation(s)/function(s) corresponding to a second portion of the machine-readable instructions represented by the flowcharts of FIGS. 4 and/or 5, and/or an ASIC may be configured and/or structured to perform third operation(s)/function(s) corresponding to a third portion of the machine-readable instructions represented by the flowcharts of FIGS. 4 and/or 5.

It should be understood that some or all of the circuitry of FIGS. 2 and 3 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIGS. 2 and 3 may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIGS. 2 and 3 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to identify revisions of components are disclosed herein. Further examples and combinations thereof include the following:

Example 1 includes an apparatus comprising interface circuitry to send a first signal to a revision-identifying circuit of an electronically controllable component of a vehicle, and receive a second signal corresponding to a revision identifier of the electronically controllable component, machine-readable instructions, and at least one processor circuit to be programmed by the machine-readable instructions to access a tuning file having a file version corresponding to the revision identifier, and control the electronically controllable component based on the tuning file.

Example 2 includes the apparatus of example 1, further including memory, wherein one or more of the at least one processor circuit is to access the tuning file in the memory from different versions of the tuning file in the memory.

Example 3 includes the apparatus of example 1 and/or example 2, wherein the electronically controllable component has mechanical characteristics corresponding to control parameters in the tuning file.

Example 4 includes the apparatus of any one or more of examples 1-3, wherein the electronically controllable component is an electronic damper in a shock absorber, one or more of the at least one processor circuit to control the electronically controllable component by based on the tuning file, obtaining at least one of an electrical current value or a voltage value corresponding to an amount of damping force to be provided by the shock absorber, and based on the at least one of electrical current value or voltage value, causing supply of an amount of at least one of electrical current or voltage to the electronic damper.

Example 5 includes the apparatus of any one or more of examples 1-4, wherein the tuning file specifies a first amount of at least one of electrical current or voltage to cause the electronically controllable component to provide a force, the first amount of at least one of electrical current or voltage different from a second amount of at least one of electrical current or voltage specified by a second file version of the tuning file corresponding to a second electronically controllable component having a second revision identifier, the second revision identifier different from the revision identifier of the electronically controllable component, the second amount of at least one of electrical current or voltage to cause the second electronically controllable component to provide the same force.

Example 6 includes the apparatus of any one or more of examples 1-5, wherein the revision-identifying circuit is at least one of a resonator circuit, an oscillator signal, or a filter circuit that is in circuit with the electronically controllable component.

Example 7 includes the apparatus of any one or more of examples 1-6, wherein the electronically controllable component is an electronic damper, the revision-identifying circuit is at least one of a resonator circuit, an oscillator signal, or a filter circuit that is in circuit with a solenoid of the electronic damper.

Example 8 includes the apparatus of any one or more of examples 1-7, wherein the electronically controllable component is a mechanically tuned component, the mechanically tuned component having mechanical characteristics responsive to different amounts of at least one of electrical current or voltage corresponding to electrical current values or voltage values obtainable using the tuning file.

Example 9 includes the apparatus of any one or more of examples 1-8, wherein the electronically controllable component is an electronic parking brake actuator, an electronic power steering motor, an electronic throttle body, a transmission solenoid, an electronic fuel injector, or an electronic engine valve.

Example 10 includes at least one non-transitory machine-readable medium comprising machine-readable instructions to cause at least one processor circuit to at least cause sending of a first signal to a revision-identifying circuit of an electronically controllable component of a vehicle, determine a revision identifier of the electronically controllable component based on a second signal from the revision-identifying circuit, access a tuning file having a file version corresponding to the revision identifier, and control the electronically controllable component based on the tuning file.

Example 11 includes the at least one non-transitory machine-readable medium of example 10, wherein the at least one processor circuit is in an electronic control unit (ECU) of the vehicle, the machine-readable instructions are to cause one or more of the at least one processor circuit to access the tuning file from different versions of the tuning file in the memory of the ECU.

Example 12 includes the at least one non-transitory machine-readable medium of example 10 and/or example 11, wherein the electronically controllable component has mechanical characteristics corresponding to control parameters in the tuning file.

Example 13 includes the at least one non-transitory machine-readable medium of any one or more of examples 10-12, wherein the electronically controllable component is an electronic damper in a shock absorber, the machine-readable instructions are to cause one or more of the at least one processor circuit to control the electronically controllable component by based on the tuning file, obtaining at least one of an electrical current value or a voltage value corresponding to an amount of damping force to be provided by the shock absorber, and based on the at least one of the electrical current value or the voltage value, causing supply of an amount of at least one of electrical current or voltage to the electronic damper.

Example 14 includes the at least one non-transitory machine-readable medium of any one or more of examples 10-13, wherein the tuning file specifies a first amount of at least one of electrical current or voltage to cause the electronically controllable component to provide a force, the first amount of at least one of electrical current or voltage different from a second amount of at least one of electrical current or voltage specified by a second file version of the tuning file corresponding to a second electronically controllable component having a second revision identifier, the second revision identifier different from the revision identifier of the electronically controllable component, the second amount of at least one of electrical current or voltage to cause the second electronically controllable component to provide the same force.

Example 15 includes the at least one non-transitory machine-readable medium of any one or more of examples 10-14, wherein the revision-identifying circuit is at least one of a resonator circuit, an oscillator signal, or a filter circuit that is in circuit with the electronically controllable component.

Example 16 includes a method comprising sending a first signal to a revision-identifying circuit of an electronically controllable component of a vehicle, receiving a second signal corresponding to a revision identifier of the electronically controllable component, accessing a tuning file having a file version corresponding to the revision identifier, and controlling the electronically controllable component based on the tuning file.

Example 17 includes the method of example 16, including accessing the tuning file from different versions of the tuning file in a memory of an electronic control unit of the vehicle.

Example 18 includes the method of example 16 and/or example 17, wherein the electronically controllable component has mechanical characteristics corresponding to control parameters in the tuning file.

Example 19 includes the method of any one or more of examples 16-18, wherein the electronically controllable component is an electronic damper in a shock absorber, the method including controlling the electronically controllable component by based on the tuning file, obtaining at least one of an electrical current value or a voltage value corresponding to an amount of damping force to be provided by the shock absorber, and based on the at least one of the electrical current value or the voltage value, supplying an amount of at least one of electrical current or voltage to the electronic damper.

Example 20 includes the method of any one or more of examples 16-19, wherein the tuning file specifies a first amount of at least one of electrical current or voltage to cause the electronically controllable component to provide a force, the first amount of at least one of electrical current or voltage different from a second amount of at least one of electrical current or voltage specified by a second file version of the tuning file corresponding to a second electronically controllable component having a second revision identifier, the second revision identifier different from the revision identifier of the electronically controllable component, the second amount of the at least one of electrical current or voltage to cause the second electronically controllable component to provide the same force.

From the foregoing, it will be appreciated that example systems, apparatus, articles of manufacture, and methods have been disclosed that identify revisions of components in a vehicle. Disclosed systems, apparatus, articles of manufacture, and methods incorporate revision-identifying circuits into electronically controllable components of a vehicle to obtain manufacturing revision numbers of the electronically controllable components. As such, ECUs of vehicles can use the revision-identifying circuits to identify manufacturing revision numbers of electronically controllable components installed in the vehicles in assembly plants during manufacturing of the vehicles or in service stations during maintenance of the vehicles. The ECUs can then identify versions of tuning files for the electronically controllable components based on the manufacturing revision numbers. The tuning files can be stored in (e.g., flashed into) the ECUs and used by the ECUs to control the electronically controllable components. Disclosed systems, apparatus, articles of manufacture, and methods are accordingly directed to one or more improvement(s) in the operation of a machine such as an ECU, a computer, and/or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to:
send a first signal to a revision-identifying circuit of an electronically controllable component of a vehicle; and
receive a second signal corresponding to a revision identifier of the electronically controllable component;
machine-readable instructions; and
at least one processor circuit to be programmed by the machine-readable instructions to:
access a tuning file having a file version corresponding to the revision identifier; and
control the electronically controllable component based on the tuning file.

2. The apparatus of claim 1, further including memory, wherein one or more of the at least one processor circuit is to access the tuning file in the memory from different versions of the tuning file in the memory.

3. The apparatus of claim 1, wherein the electronically controllable component has mechanical characteristics corresponding to control parameters in the tuning file.

4. The apparatus of claim 1, wherein the electronically controllable component is an electronic damper in a shock absorber, one or more of the at least one processor circuit to control the electronically controllable component by:
based on the tuning file, obtaining at least one of an electrical current value or a voltage value corresponding to an amount of damping force to be provided by the shock absorber; and
based on the at least one of electrical current value or voltage value, causing supply of an amount of at least one of electrical current or voltage to the electronic damper.

5. The apparatus of claim 1, wherein the tuning file specifies a first amount of at least one of electrical current or voltage to cause the electronically controllable component to provide a force, the first amount of at least one of electrical current or voltage different from a second amount of at least one of electrical current or voltage specified by a second file version of the tuning file corresponding to a second electronically controllable component having a second revision identifier, the second revision identifier different from the revision identifier of the electronically controllable component, the second amount of at least one of electrical current or voltage to cause the second electronically controllable component to provide the same force.

6. The apparatus of claim 1, wherein the revision-identifying circuit is at least one of a resonator circuit, an oscillator signal, or a filter circuit that is in circuit with the electronically controllable component.

7. The apparatus of claim 1, wherein the electronically controllable component is an electronic damper, the revision-identifying circuit is at least one of a resonator circuit, an oscillator signal, or a filter circuit that is in circuit with a solenoid of the electronic damper.

8. The apparatus of claim 1, wherein the electronically controllable component is a mechanically tuned component, the mechanically tuned component having mechanical characteristics responsive to different amounts of at least one of electrical current or voltage corresponding to at least one of electrical current values or voltage values obtainable using the tuning file.

9. The apparatus of claim 1, wherein the electronically controllable component is an electronic parking brake actuator, an electronic power steering motor, an electronic throttle body, a transmission solenoid, an electronic fuel injector, or an electronic engine valve.

10. At least one non-transitory machine-readable medium comprising machine-readable instructions to cause at least one processor circuit to at least:
cause sending of a first signal to a revision-identifying circuit of an electronically controllable component of a vehicle;
determine a revision identifier of the electronically controllable component based on a second signal from the revision-identifying circuit;
access a tuning file having a file version corresponding to the revision identifier; and
control the electronically controllable component based on the tuning file.

11. The at least one non-transitory machine-readable medium of claim 10, wherein the at least one processor circuit is in an electronic control unit (ECU) of the vehicle, the machine-readable instructions are to cause one or more of the at least one processor circuit to access the tuning file from different versions of the tuning file in a memory of the ECU.

12. The at least one non-transitory machine-readable medium of claim 10, wherein the electronically controllable component has mechanical characteristics corresponding to control parameters in the tuning file.

13. The at least one non-transitory machine-readable medium of claim 10, wherein the electronically controllable component is an electronic damper in a shock absorber, the machine-readable instructions are to cause one or more of the at least one processor circuit to control the electronically controllable component by:
based on the tuning file, obtaining at least one of an electrical current value or a voltage value corresponding to an amount of damping force to be provided by the shock absorber; and
based on the at least one of the electrical current value or the voltage value, causing supply of an amount of at least one of electrical current or voltage to the electronic damper.

14. The at least one non-transitory machine-readable medium of claim 10, wherein the tuning file specifies a first amount of at least one of electrical current or voltage to cause the electronically controllable component to provide a force, the first amount of at least one of electrical current or voltage different from a second amount of at least one of electrical current or voltage specified by a second file version of the tuning file corresponding to a second electronically controllable component having a second revision identifier, the second revision identifier different from the revision identifier of the electronically controllable component, the second amount of at least one of electrical current or voltage to cause the second electronically controllable component to provide the same force.

15. The at least one non-transitory machine-readable medium of claim 10, wherein the revision-identifying circuit is at least one of a resonator circuit, an oscillator signal, or a filter circuit that is in circuit with the electronically controllable component.

16. A method comprising:
sending a first signal to a revision-identifying circuit of an electronically controllable component of a vehicle;
receiving a second signal corresponding to a revision identifier of the electronically controllable component;
accessing a tuning file having a file version corresponding to the revision identifier; and
controlling the electronically controllable component based on the tuning file.

17. The method of claim 16, including accessing the tuning file from different versions of the tuning file in a memory of an electronic control unit of the vehicle.

18. The method of claim 16, wherein the electronically controllable component has mechanical characteristics corresponding to control parameters in the tuning file.

19. The method of claim 16, wherein the electronically controllable component is an electronic damper in a shock absorber, the method including controlling the electronically controllable component by:
based on the tuning file, obtaining at least one of an electrical current value or a voltage value corresponding to an amount of damping force to be provided by the shock absorber; and
based on the at least one of the electrical current value or the voltage value, supplying an amount of at least one of electrical current or voltage to the electronic damper.

20. The method of claim 16, wherein the tuning file specifies a first amount of at least one of electrical current or voltage to cause the electronically controllable component to provide a force, the first amount of at least one of electrical current or voltage different from a second amount of at least one of electrical current or voltage specified by a second file version of the tuning file corresponding to a second electronically controllable component having a second revision identifier, the second revision identifier different from the revision identifier of the electronically controllable component, the second amount of the at least one of electrical current or voltage to cause the second electronically controllable component to provide the same force.
